(19) United States
(12) Patent Application Publication
(10) Pub. No.: US 2009/0110845 A1
(43) Pub. Date: Apr. 30, 2009

(54) METHODS FOR BONDING HIGH TEMPERATURE SENSORS

(75) Inventors: Qiwei Lu, Schenectady, NY (US); Robert James Perry, Niskayuna, NY (US); Ying Fan, Niskayuna, NY (US); Kevin Warner Flanagan, Troy, NY (US); James Norman Barshinger, Scotia, NY (US); Wendy Wen-Ling Lin, Niskayuna, NY (US); Irene Dris, Raritan, NJ (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/927,756

(22) Filed: Oct. 30, 2007

(51) Int. Cl. B05D 3/00; B05D 3/12; B05D 5/10; B05D 7/00

(52) U.S. Cl. 427/543; 427/180; 427/208.2; 427/560

(57) ABSTRACT

The invention provides a method of bonding a sensor to a surface comprising the steps of applying a thermoplastic film to a first surface of the sensor. The first surface of the sensor is contacted with a surface of an object to be monitored, wherein the composition effectively bonds the sensor to the object surface at a temperature up to approximately 250° C. The invention also provides a method of bonding a sensor to a surface comprising the steps of applying a thermoplastic film to a surface area of an object to be monitored. The first surface of a sensor is contacted with the object surface area, wherein the film effectively bonds the sensor to the object surface at a temperature up to approximately 250° C.

### TECHNICAL FIELD

The invention includes embodiments that relate to methods of using thermoplastic films as bonding layers for high temperature sensors.

### BACKGROUND

Corrosion monitoring using ultrasonic nondestructive evaluation is a well-known plant management tool in the oil and gas industry. The current inspection paradigm involves periodic inspection of plant assets at predetermined TMLs (thickness measurement locations) using a handheld ultrasonic thickness gauge. A limitation of this solution is that a majority of the inspection cost involves gaining access to the TML by erecting scaffolding, stripping insulation, etc.

A newer system for ultrasonic thickness measurement is to permanently install ultrasonic sensors and instrumentation at the TMLs. Thus, it is only necessary to access the structure at the time of installation of the sensors. Once the sensors are installed, thickness measurements can be collected remotely at the desired inspection intervals.

Adhesive technology has a critical need for a more permanent installation of ultrasonic sensors. Adhesives perform two functions. Adhesives are used to physically attach the sensor to the plant asset at the TML, and adhesives are needed to transmit ultrasonic energy through the adhesive layer. Furthermore, the adhesives must perform these functions for a long duration of time, and in the harsh environments present in the oil and gas industry, including temperatures in the range of 125° C. to 250° C. or higher.

### BRIEF DESCRIPTION

The above-described problems are alleviated by an adhesive technology that effectively meets the requirements for permanently installed high temperature sensors. In one embodiment, the invention provides a method of bonding a sensor to a surface comprising the steps of applying a thermoplastic film to a first surface of a sensor; and contacting the first surface of the sensor to a surface of an object to be monitored; wherein the film effectively bonds the sensor to the object surface at a temperature up to approximately 250° C.

In another embodiment, the invention provides a method of bonding a sensor to a surface comprising the steps of applying a thermoplastic film to a surface area of an object to be monitored; and contacting a first surface of a sensor to the object surface area; wherein the film effectively bonds the sensor to the object surface at a temperature up to approximately 250° C.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a graph of TGA profiles of representative thermoplastics with good processibility.

FIG. 2 is a graph of TGA profiles of PEEK and PEK materials.

FIG. 3 is a graph of TGA profiles of Victrex 10009 PEEK at different heating rates.

FIG. 4 is a graph of a life expectancy curve for titanium delay line samples.

FIG. 5 is a graph of a life expectancy curve for Macor delay line samples.

FIG. 6 is a graph of a life expectancy curve for surface treated titanium delay line samples.

### DETAILED DESCRIPTION

In the methods of the invention, a thermoplastic film is used to bond high temperature sensors to the surface of objects to be monitored. The thermoplastic film provides superior mechanical integrity, strong adhesion, high toughness and excellent thermal stability.

Suitable thermoplastic polymers the film may be comprised of include, for example polysulfone, poly(phenylene sulfide) (PPS), polyimide (PI), poly(ether ether ketone) (PEEK), poly(ether ketone) (PEK), poly(ether ketone ketone) (PEKK), liquid crystalline polyester (LCP), poly(arylene ether) and the like. All of these thermoplastic polymers are known in the art and are both widely commercially available and preparable by known methods. Preferably, the thermoplastic film is comprised of PEEK.

In one embodiment, the thermoplastic film has a softening point of about 200° C. to about 400° C. The softening point refers to the glass transition temperature for amorphous polymers (e.g. polyimide, polysulfone) and refers to the melting point for semi-crystalline polymers (e.g. PEEK, PEK, liquid crystalline polyester, poly(phenylene sulfide)). The softening points may be determined according to ASTM E28-99 (2004).

The thermoplastic film may comprise from about 10 weight percent to about 100 weight percent of a thermoplastic polymer. Preferably, the thermoplastic film comprises from about 60 weight percent to about 100 weight percent of a thermoplastic polymer.

The thermoplastic film may, optionally, further comprise one or more additives known in the art. Such additives include, for example, fillers, thermal stabilizers, plasticizers, UV stabilizers, process aids and the like, and combinations thereof. Those skilled in the art can select suitable additives and amounts. The additives should be chosen so as not to adversely affect the thermal or acoustic properties of the thermoplastic film.

The thermoplastic film effectively bonds or secures sensors at elevated temperatures, as well as ambient and sub-ambient temperatures. Specifically, the thermoplastic film is capable of effectively bonding or securing a sensor to the surface of an object to be monitored, wherein the surface has a temperature up to approximately 250° C. Preferably the object surface has a temperature between approximately 125° C. and approximately 250° C., and more preferably between approximately 125° C. and approximately 200° C. The thermoplastic film is capable of effectively bonding or securing a sensor to an object surface at temperatures up to about 250° C. for a period of at least five years without appreciable loss of mechanical and acoustic properties of the film.

In addition, the thermoplastic film preferably has a thickness between approximately 1 mil and approximately 2 mm. More preferably, the thermoplastic film has a thickness between approximately 2 mil and approximately 20 mil.

As the thermoplastic film is defined as comprising multiple components, it will be understood that each component is chemically distinct, particularly in the instance that a single chemical compound may satisfy the definition of more than one component.

In one embodiment, the thermoplastic film is applied to a surface of the sensor. Any method known to those having skill in the art may be used to apply the thermoplastic film including, but not limited to compression molding, laminating, spraying, powder coating, and the like, or a combination thereof. The surface of the sensor having the thermoplastic film thereon is then contacted with the surface of the object to be monitored. Alternatively, the thermoplastic film may be applied to the surface area of an object to be monitored. Suitable methods of applying the film to the object surface include induction welding, laminating, spraying, powder coating, and the like, or a combination thereof. A surface of the sensor is then contacted with the surface area of the object having the film thereon.

In the methods of the invention, the object surface or the sensor surface, or both, may be mechanically, chemically, or electrochemically treated to form a strong bonding surface. Common methods of treating the object surface include, for example, grit blasting, silane treatment, silicon sputtering, Corona discharge or anodization with, for example, sodium hydroxide or chromic acid.

The thermoplastic film may be melted prior to, during, or after contacting the surface of the sensor with the object surface to aid in securing the sensor to the object surface. Any method known to those having skill in the art may be used to melt the thermoplastic film including, but not limited to sonication, pressure, heat for example via induction heating or use of a heat gun, and the like. For example, the temperature of the object surface may be raised via induction heating prior to, during, or after the thermoplastic film is applied/contacted to the object surface, thereby melting the thermoplastic film. In the induction heating process, an alternating current is passed through a conductive coil situated near the object. The resulting alternating electromagnetic field generates eddy currents in the electrically conductive object, thereby heating the object through Joule heating, as well as hysteretic heating in cases where the object is ferromagnetic. By this technique, the object can be heated to a temperature sufficient to melt the thermoplastic film in contact with the object, thereby bonding the sensor to the object surface in accordance with the invention.

The basic components of an induction heating system are an AC power supply and an induction coil. Other features may be incorporated, as desired or necessary. One typical feature is a cooling system to dissipate heat from the power supply and coil during use. Another typical feature is a method of measuring the temperature of the object in order to record and control the rate and extent of heating. Those skilled in the art will recognize that various factors may be adjusted to optimize the heating rate, the maximum temperature, and the area in which heating will occur. These include, but are not limited to, the geometry of the coil; the current, voltage, and frequency at which the system is operated; and the proximity of the coil to the object. In one embodiment, the induction heating system is a NovaStar 5 kW power supply and heat station, produced by Ameritherm, Inc. This system may be fitted with an induction coil fabricated from hollow copper tubing. The power supply, work station, and coil may be cooled via an integral circulating water loop. In addition, multiple thermocouple probes positioned on the object and sensor may be used to measure the temperature of these components.

As with other techniques for melting the thermoplastic film and bonding the sensor, various methods of applying pressure to the sensor may be used, in order to achieve a more uniform and durable bond between the sensor and object surface. These methods may include, but are not limited to, vacuum bagging, clamping, or application of a static weight.

The adhesive composition is particularly useful in bonding sensors to test objects such as pipes, vessels, and metal structures, which are the basic structures found in oil and gas refineries, power plants and aerospace industry. The sensors monitor the corrosion rates of the object wall, which may operate at temperatures approaching 250° C. The adhesive composition may be used to bond various types of sensors, including but not limited to acoustic sensors, vibration sensors and gas sensors.

The invention is further illustrated by the following non-limiting examples.

### EXAMPLE 1

The screening of materials was accomplished by sandwiching a potential adhesive between a steel coupon (1″×1″× 3/16″ thick) and a cylinder of titanium (½″×½″) or a cube of Macor ceramic (½″) as the delay line surrogate. The adhesive, coupon and delay line were assembled together with applied heat and pressure. After cooling to ambient temperature, the two substrates glued together were manually stressed (pulled-off and twisted) to see if the materials remained attached. The adhesives that were acceptable after the initial crude testing were then down-selected based on availability, ease of application, and thermal characteristics.

Subsequent to the initial assembly of the test samples, a more reproducible method for the construction of the test samples was devised. The adhesive film was pressed between the delay line and a heated steel coupon by a spring press pushing on a ceramic ball, used to apply even pressure on the sample.

After the coupon was well attached and brought to ambient temperature, a drop of glycerin was applied to the top surface of the delay line and acoustic readings were taken using an ultrasound pulse/echo technique. If the initial signal strength was acceptable, the assembly was placed in a forced air oven at 250° C. or higher for acceleration. At timed intervals, the samples were removed and examined for adhesion and signal quality.

The thermoplastic candidates used as hot-melt glue were further divided into amorphous and semi-crystalline polymers. The glass transition temperature (Tg) of an amorphous thermoplastic or the melting point (Tm) of a semi-crystalline thermoplastic must be higher than the highest service temperature. Auxiliary fixation (e.g. mechanical clamping) and sealing (e.g. use of water glass around the edge) may become necessary to provide further protection against vibration, creeping, or exposure to oxygen, moisture, UV radiation, or chemicals, etc.

Amorphous thermoplastics, encompassing a variety of high temperature polymers such as polyimide, polybenzoxazole (PBO), polybenzimidazole (PBI), and polysulfone (PSF), were the first class tested. All materials considered in this set were highly aromatic in nature and known for high temperature stability as shown in Table 1.

TABLE 1

| Category | Material Type | Name | Manufacturer | Thermal Characteristics (° C.) |
|---|---|---|---|---|
| Amorphous Thermoplastic | Polysulfone | Supradel HTS | Solvay | Tg = 265, HDT = 255 |
| | Polysulfone | ZYS-364-2 | GE GRC | Tg = 285 |
| | Polysulfone | ABK40A | GE GRC | Tg = 303 |
| | Polysulfone | ABK72A | GE GRC | Tg = 284 |
| | Polyimide | Kapton | duPont | Tg ~ 360 |
| | Polyimide | Ultem 1000 | GE | Tg = 234 |
| | Polyimide | Extem P1 | GE | Tg = 310 |
| | Polyimide | Extem P2 | GE | Tg = 265 |
| | Polyimide | Extem P3 | GE | Tg = 255 |
| Semi-XL'n Thermoplastic | PEEK | Victrex 450G | Victrex | Tm = 334 |
| | PEEK | Victrex 1000 | Victrex | more pure version of Victrex 450G |
| | PEK | Victrex G22 | Victrex | |
| | PEK | Victrex G45 | Victrex | |
| | PPS | Ryton | Phillips | |
| | PPS | | Aldrich 427268 | Tm = 285-300 |
| | PPS | | Aldrich 182354 | Tg = 150 |
| | LCP | Xydar SRT900 | Solvay | |
| | LCP | Vectra | Vectran | Tm = 270-330 |
| | LCP | Zenite 6000 | duPont | |
| | PPE | P3O | GE | Tg = 225; Tm = 460 |

Referring to Table 1, the high heat Ultem® and Extem® polymers could be heated beyond their softening point and adhered well to steel and the delay line materials.

The semi-crystalline thermoplastics, represented by liquid crystalline polyesters (LCPs), polyetheretherketone (PEEK), polyetherketone (PEK), poly(2,6-diphenylphenylene ether) (P3O), and poly(phenylene sulfide) (PPS), were also examined. The LCP's, PEK and PEEK materials in this category all stuck reasonably well to the steel plate and the delay line.

### EXAMPLE 2

### Thermal Stability

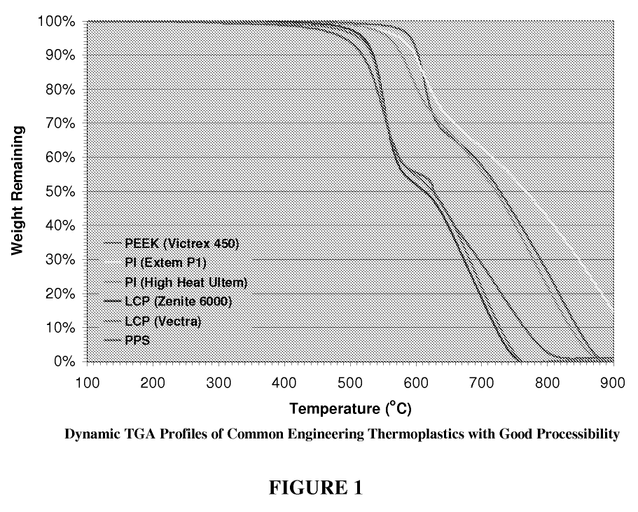

FIG. 1 shows the thermogravimetric analyses (TGA) of the polymeric adhesives. Estimation of the activation energies of thermal degradation is shown in Table 2. Activation energies of a material were calculated from the thermal decomposition curves obtained from TGA measurements.

TABLE 2
TGA Results and Calculated Activation Energies of High Heat
Thermoplastics

| | | | LCP | PI (High | PI | PEEK |
|---|---|---|---|---|---|---|
| | | LCP | (Zenite | Heat | (Extem | (Victrex |
| | PPS (Aldrich) | (Vectra ®) | 6000 ®) | Ultem ®) | P1 ®) | 450 ®) |
| Tᵢ (° C.)^{a} | 481 | 502 | 505 | 540 | 550 | 569 |
| Tₚ (° C.)^{b} | 550 | 547 | 554 | 593 | 612 | 614 |
| Eₐ (kJ/mol)^{c} | 144 | 232 | 239 | 179 | 197 | 382 |

Note:
^{a}Tᵢ = Initial decomposition temperature, intersection of tangents of initial plateau and first drop
^{b}Tₚ = Peak decomposition temperature, maximum of the derivative of weight loss over temperature
^{c}Eₐ = Activation energy of thermal decomposition, determined by Coats-Redfern Method (A. W. Coats, J. P. Redfern. J Polym Sci Part B-Polym Lett (1965), 3, 917)

The thermal degradation of thermoplastic and thermoset materials was performed in a thermogravimetric analyzer (TGA7, Perkin-Elmer) under dynamic conditions between 30° C. and 900° C. at a programmed heating rate of 10° C./min or isothermal conditions at 300° C. for 48 hr in both a nitrogen and air atmosphere with a gas flow of 20 mL/min. Other heating rates of 2, 5, 15, and 20° C./min were also employed for the dynamic mode. A sample with an average mass of approximately 6 mg was loaded.

As shown in Table 2, PEEK showed higher thermal stability than other thermoplastics with the highest initial thermal decomposition temperature at 569° C. Extem P1® aromatic polyimide also demonstrated good resistance to heat. PPS and LCPs started to decompose approximately 100° C. lower than PEEK and Extem P1®. The activation energies of the thermal decomposition from the single dynamic TGA curve were calculated using the Coats & Redfern method. PEEK showed a high activation energy value of 382 kJ/mol.

TABLE 3
Initial Thermal Decomposition Temperatures of PEEKs and PEKs

| | PEEK | PEEK | PEK | PEK |
|---|---|---|---|---|
| | (Victrex 450) | (Victrex 1000) | (Victrex G22) | (Victrex G45) |
| Tᵢ | 569 | 583 | 571 | 568 |
| (° C.) | | | | |

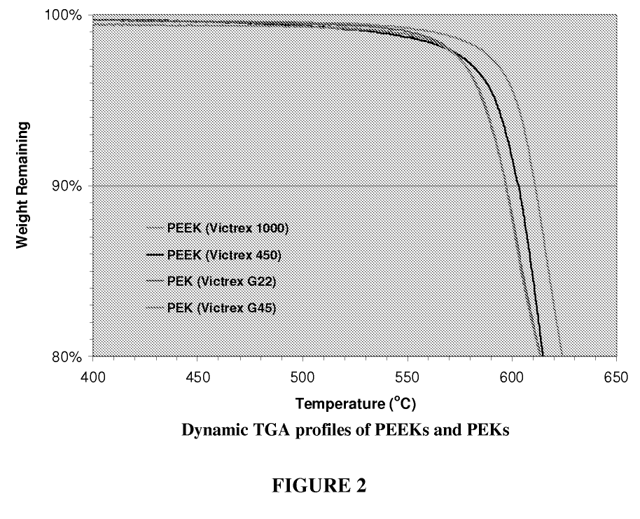

Table 3 and FIG. 2 each show a comparison of the thermal decomposition of general purpose grade PEEK (Victrex 450®), a high purity PEEK (Victrex 1000®) and two PEKs. The TGA results illustrated in FIG. 2 and Table 3 indicate that purity as well as chemical structure are important factors in thermal stability. The high purity grade PEEK (Victrex 1000®) was the most thermally stable of these materials.

### EXAMPLE 3

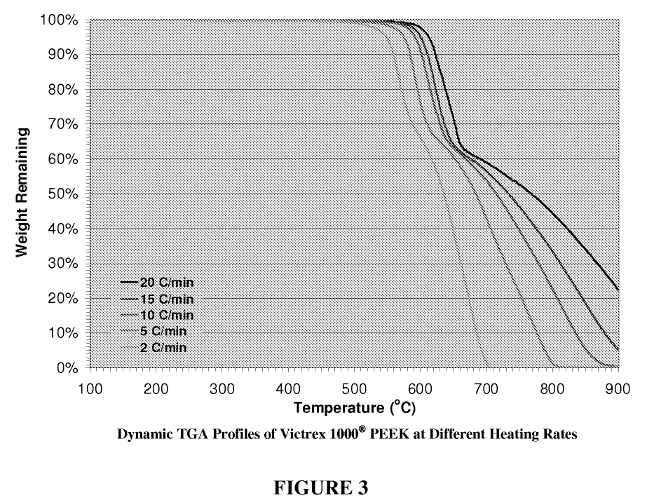

A more accurate estimation of activation energy and RTI (relative thermal index) was achieved via thermogravimetric analysis using different scanning rates. Referring to FIG. 3, the activation energy of the high purity Victrex 1000® PEEK was 510 kJ/mol. The acceleration factor for Victrex 1000® PEEK from 250° C. to 300° C. based on 500 kJ/mol (@ 5% weight loss in the TGA) was as high as 24000×.

### EXAMPLE 4

### Long Term Aging of Thermoplastic Materials

Two thermoplastic materials, PEEK and Extem, were selected as the candidates for sensor attachment. For high temperature accelerated life testing, coupons were manufactured using these thermoplastic materials. Each coupon contained a ½″ by ½″ cylindrical delay-line and a 1″×1″ square plate made of stainless steel. The delay-line materials were either titanium or Macor (machinable ceramic). The life tests included a high temperature soaking test and a thermal cycling test.

The purpose of the high temperature soaking test was to evaluate the thermal stability of the thermoplastic bonds and to extrapolate a life expectancy curve at high temperatures (250° C.-300° C.). The goal of the thermal cycling test was to investigate the adhesion of thermoplastic bonds under high thermal stress conditions. Three elevated temperatures were selected for high temperature soaking tests: 271° C., 288° C. and 298° C. The selection of these temperatures was based on the following criteria: 1) for the accelerated life test, the temperatures should be higher than the operating temperature of 250° C.; 2) the testing temperatures should not exceed the melting temperature of thermoplastic material; 3) the testing temperatures should not introduce extra failure modes at the interface; and 4) instrument capability. The thermal cycling tests were carried out at 250° C. at timed intervals and the samples were removed and examined for adhesion and signal quality.

### High Temperature Soaking Test

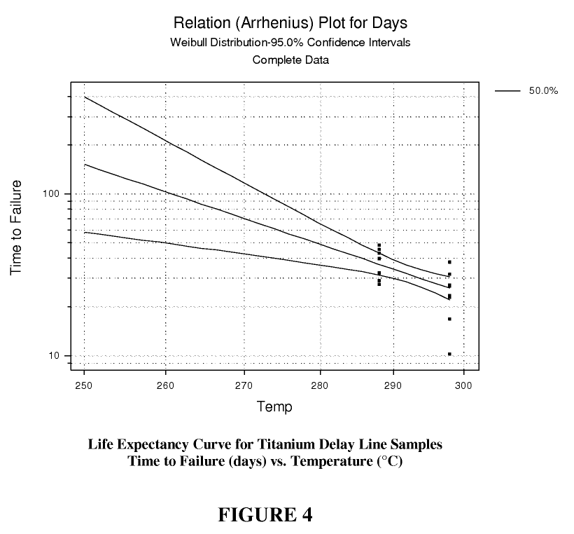

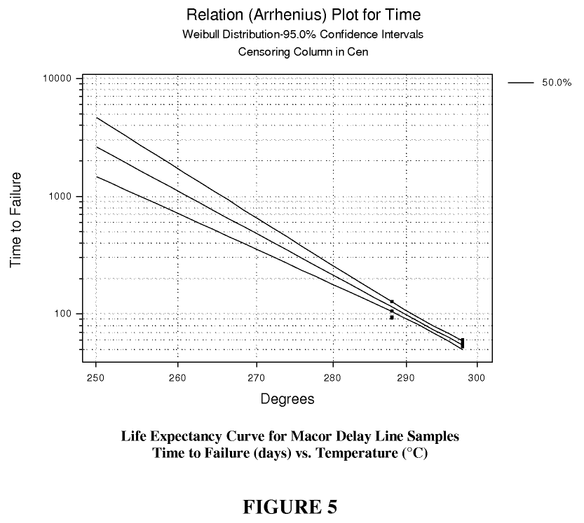

Table 4 shows the life of coupons made of thermoplastics. The extrapolated life expectancy curve for the titanium delay line samples is displayed in FIG. 4, and the life expectancy curve for the Macor delay line samples is shown in FIG. 5. Based on the statistical analysis, the life expectancy for a Macor-PEEK-Steel assembly at 250° C. is approximately 4 to 12 years. The life expectancy for a Titanium-PEEK-Steel assembly at 250° C. is approximately 0.2 to 1 year. For titanium delay line samples, surface treatments on titanium were proposed to improve the titanium-polymer adhesion.

TABLE 4
Soaking Test results obtained at 288° C. and 298° C.

| Delay-line | Adhesive | Temperature ° C. | Life (days) |
|---|---|---|---|
| Ti | PEEK | 288 | 32 |
| Ti | PEEK | 288 | 29 |
| Ti | PEEK | 288 | 46 |
| Ti | PEEK | 288 | 39 |
| Ti | PEEK | 288 | 27 |
| Ti | PEEK | 288 | 32 |
| Ti | PEEK | 288 | 39 |
| Ti | PEEK | 288 | 43 |
| Ti | PEEK | 288 | 49 |
| Ti | Extem P1 | 288 | 50 |
| Ti | Extem P1 | 288 | 3 |
| Ti | Extem P1 | 288 | 3 |
| Ti | PEEK | 298 | 10 |
| Ti | PEEK | 298 | 23 |
| Ti | PEEK | 298 | 23 |
| Ti | PEEK | 298 | 38 |
| Ti | PEEK | 298 | 17 |
| Ti | PEEK | 298 | 27 |
| Ti | PEEK | 298 | 27 |
| Ti | PEEK | 298 | 27 |
| Ti | PEEK | 298 | 32 |
| Macor | PEEK | 288 | 93 |
| Macor | PEEK | 288 | 93 |
| Macor | PEEK | 288 | 105 |
| Macor | PEEK | 288 | 125 |
| Macor | PEEK | 288 | 139 |
| Macor | Extem P1 | 288 | 85 |
| Macor | Extem P1 | 288 | 92 |
| Macor | Extem P1 | 288 | 102 |
| Macor | Extem P1 | 288 | 13 |
| Macor | Extem P1 | 288 | 6 |
| Macor | Extem P1 | 288 | 3 |
| Macor | PEEK | 298 | 53 |
| Macor | PEEK | 298 | 53 |
| Macor | PEEK | 298 | 53 |
| Macor | PEEK | 298 | 56 |
| Macor | PEEK | 298 | 60 |

### Thermal Cycling Test

The coupons with PEEK on a titanium delay line failed acoustically at 120 thermal cycles between room temperature and 250° C. due to delamination. The coupons with PEEK on a Macor delay line were still intact after surpassing 850 cycles.

### EXAMPLE 5

### Surface Treatment of Titanium

To improve adhesion, the surface of titanium should be mechanically, chemically, or electrochemically treated to allow stronger bonding to occur that will lead to improved durability. Common methods include acid etch, grit blasting, vapor blasting, silane treatment, silicon sputtering, anodization, corona discharge, and combinations thereof. Sodium hydroxide anodization and chemical etching were performed on titanium samples.

A thermal cycling test was used as the screening procedure to validate the effectiveness of adhesion improvement. The results are shown in Table 5. These results indicated that sandblast followed by NaOH anodization was an effective technique to enhance the titanium-PEEK adhesion.

TABLE 5
Thermal cycle test results on surface treated titanium

| | | | Life | Number |
|---|---|---|---|---|
| Delayline | Adhesive | Treatment | Cycle | Failed |
| Ti | PEEK | Sandblast | 120 | 4 |
| Ti | PEEK | Grit Sandblast | 260 | 4 |
| Ti | PEEK | Grit Sandblast + NaOH Anodize | 450 | 4 |
| Ti | PEEK | Glass Bead Sandblast + | 450 | 4 |
| | | NaOH Anodize + Si Sputter | | |
| Ti | PEEK | Grit Sandblast + | 350 | 4 |
| | | NaOH Anodize + Si Sputter | | |
| Ti | PEEK | Grit Sandblast + Primer | 350 | 4 |
| Ti | Extem P1 | Grit Sandblast | 160 | 4 |
| Ti | Extem P1 | Grit Sandbalst + NaOH Anodize | 150 | 4 |
| Macor | PEEK | Sandpaper | >850 | 0 |
| Macor | Extem P1 | Sandpaper | 460 | 4 |

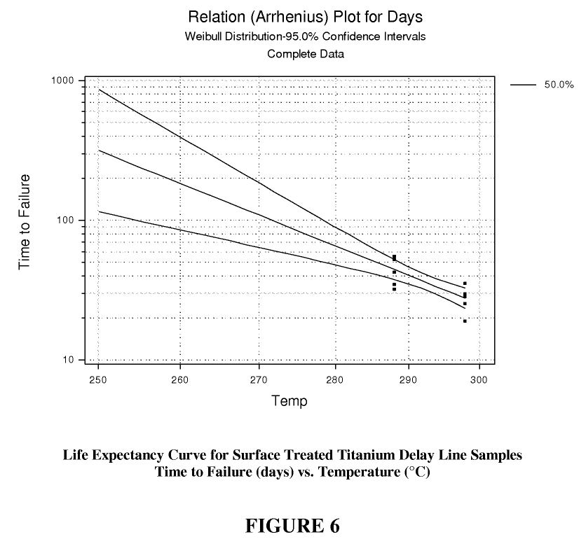

Additional samples were fabricated using the surface treated titanium for the high temperature soaking test. These results are presented below in Table 6. Furthermore, as shown by statistical analysis in FIG. 6, the life expectancy of a surface treated Titanium-PEEK-Steel assembly at 250° C. is approximately 0.3 to 2.3 years.

TABLE 6
High temp soaking test of surface treated titanium
delay line samples.

| Delay-line | Adhesive | Temp (° C.) | Life (days) |
|---|---|---|---|
| Ti | PEEK | 288 | 32 |
| Ti | PEEK | 288 | 52 |
| Ti | PEEK | 288 | 43 |
| Ti | PEEK | 288 | 55 |
| Ti | PEEK | 288 | 35 |
| Ti | PEEK | 298 | 30 |
| Ti | PEEK | 298 | 25 |
| Ti | PEEK | 298 | 35 |
| Ti | PEEK | 298 | 28 |
| Ti | PEEK | 298 | 19 |

All cited patents, patent applications, and other references are incorporated herein by reference in their entirety.

All ranges disclosed herein are inclusive of the endpoints, and the endpoints are combinable with each other.

It is to be noted that the terms “first,” “second,” and the like as used herein do not denote any order, quantity, or importance, but rather are used to distinguish one element from another. The modifiers “about” and “approximately” used in connection with a quantity is inclusive of the stated value and has the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of bonding a sensor to a surface comprising the steps of:
applying a thermoplastic film to a first surface of a sensor; and
contacting the first surface of the sensor to a surface of an object to be monitored;
wherein the film effectively bonds the sensor to the object surface at a temperature up to approximately 250° C.

2. The method of claim 1, wherein the thermoplastic film is applied to the first surface of the sensor by compression molding, laminating, spraying, powder coating or a combination thereof.

3. The method of claim 1, further comprising:
melting the thermoplastic film prior to, during, or after contacting the first surface of the sensor with the object surface.

4. The method of claim 1, wherein the thermoplastic film is melted by sonication, pressure, heat or a combination thereof.

5. The method of claim 4, wherein the thermoplastic film is melted by induction heating.

6. The method of claim 1, wherein the thermoplastic film is capable of effectively bonding the sensor to the object surface for a period of approximately five years.

7. The method of claim 1, wherein the thermoplastic film has a softening point of about 200° C. to about 400° C.

8. The method of claim 1, wherein the thermoplastic film has a thickness between approximately 1 mil and approximately 2 mm.

9. The method of claim 1, wherein the thermoplastic film is comprised of polysulfone, poly(phenylene sulfide), polyimide, poly(ether ether ketone), poly(ether ketone), poly(ether ketone ketone), liquid crystalline polyester, or poly(arylene ether).

10. The method of claim 1, further comprising:
treating the object surface via acid etch, grit blasting, vapor blasting, silane treatment, silicon sputtering, anodization, corona discharge, or a combination thereof;
prior to contacting the first surface of the sensor to the surface of the object.

11. A method of bonding a sensor to a surface comprising the steps of:
applying a thermoplastic film to a surface area of an object to be monitored; and
contacting a first surface a sensor to the object surface area;
wherein the film effectively bonds the sensor to the object surface at a temperature up to approximately 250° C.

12. The method of claim 11, wherein the thermoplastic film is applied to the object surface by induction welding, laminating, spraying, powder coating or a combination thereof.

13. The method of claim 11, further comprising:
melting the thermoplastic film prior to, during, or after contacting the first surface of the sensor with the object surface.

14. The method of claim 13, wherein the thermoplastic film is melted by sonication, pressure, heat or a combination thereof.

15. The method of claim 14, wherein the thermoplastic film is melted by induction heating.

16. The method of claim 11, wherein the thermoplastic film is capable of effectively bonding the sensor to the surface for a period of approximately five years.

17. The method of claim 11, wherein the thermoplastic film has a softening point of about 200° C. to about 400° C.

18. The method of claim 11, wherein the thermoplastic film has a thickness between approximately 1 mil and approximately 2 mm.

19. The method of claim 11, wherein the thermoplastic film is comprised of polysulfone, poly(phenylene sulfide), polyimide, poly(ether ether ketone), poly(ether ketone), poly(ether ketone ketone), liquid crystalline polyester, or poly(arylene ether).

20. The method of claim 11, further comprising:
treating the object surface via acid etch, grit blasting, vapor blasting, silane treatment, silicon sputtering, anodization, corona discharge, or a combination thereof;
prior to contacting the first surface of the sensor to the surface of the object.
